(19) United States
(12) Patent Application Publication
(10) Pub. No.: US 2021/0408806 A1
(43) Pub. Date: Dec. 30, 2021

(54) CHARGE BALANCING FOR A MULTI-BAY POWER SUPPLY

(71) Applicant: MILWAUKEE ELECTRIC TOOL CORPORATION, Brookfield, WI (US)

(72) Inventors: Zachary G. Stanke, Wausau, WI (US); Samuel Sheeks, Germantown, WI (US)

(21) Appl. No.: 17/357,238

(22) Filed: Jun. 24, 2021

Related U.S. Application Data
(60) Provisional application No. 63/043,858, filed on Jun. 25, 2020.

(51) Int. Cl. H02J 7/00; H05B 1/02

(52) U.S. Cl. CPC H02J 7/0016; B25F 5/00; H05B 1/0272; H02J 7/0048

(57) ABSTRACT

A multi-bay power supply including a plurality of energy storage devices, a power output configured to provide power from the plurality of energy storage devices to a peripheral device, and a controller including an electronic processor. The controller is configured to determine which battery of the plurality of energy storage devices has a highest state of charge, provide power to the peripheral device by discharging the energy storage device having the highest state of charge for a first configurable amount of time. The controller is further configured to provide power to the peripheral device by discharging the energy storage devices having the highest state of charge and any energy storage devices in the plurality of energy storage devices having a state of charge that is within a tolerance of the highest state of charge.

### RELATED APPLICATIONS

This application claims the benefit of U.S. Provisional Patent Application No. 63/043,858, filed Jun. 25, 2020, the entire content of which is hereby incorporated by reference.

### FIELD

Embodiments described herein relate to multi-bay power supplies.

### SUMMARY

Multi-bay battery or battery pack systems (i.e., a multi-bay power supply) can include multiple batteries or multiple battery packs. However, unlike singular battery packs, there is no guarantee that the separate batteries included in the multi-bay battery system or packs in a battery pack system are the same age, capacity, or charge status. Accordingly, during operation of a multi-bay power supply, current drawn from each of the multiple batteries or battery packs may result in imbalances between charge levels of the different batteries or battery packs. Large imbalances between charge levels may result in reduced runtime of the multi-bay power supply.

Multi-bay power supplies described herein include a plurality of energy storage devices, a power output configured to provide power from the plurality of energy storage devices to a peripheral device, and a controller including an electronic processor. The controller is configured to determine which energy storage device of the plurality of energy storage devices has a highest state of charge, provide power to the peripheral device by discharging the energy storage device having the highest state of charge for a first configurable amount of time, and determine whether any energy storage devices in the plurality of energy storage devices have a state of charge that is within a tolerance of the highest state of charge. The controller is further configured to provide power to the peripheral device by discharging the energy storage device having the highest state of charge and any energy storage devices in the plurality of energy storage devices having a state of charge that is within the tolerance of the highest state of charge.

Methods described herein provide for discharging a multi-bay power supply. The multi-bay battery supply includes a plurality of energy storage devices, a power output configured to provide power from the plurality of energy storage devices to a peripheral device, and a controller including an electronic processor. The methods include determining, using the controller, which energy storage device in the plurality of energy storage devices has a highest state of charge, activating, using the controller, the energy storage device having the highest state of charge to enable power flow from the energy storage device having the highest state of charge to the peripheral device, and discharging, using the controller, the energy storage device having the highest state of charge for a first configurable amount of time. The methods further include determining, using the controller, whether any energy storage devices in the plurality of energy storage devices have a state of charge that is within a tolerance of the highest state of charge, activating, using the controller, any energy storage devices in the plurality of energy storage devices having a state of charge that is within the tolerance of the highest state of charge to enable power flow from the energy storage devices having states of charge within the acceptable tolerance to the peripheral device, and discharging, using the controller, the energy storage devices having the highest state of charge and the energy storage devices having states of charge within the acceptable tolerance for a second configurable amount of time.

Methods described herein provide for charging a multi-bay power supply. The multi-bay power supply includes a plurality of energy storage devices, a power input configured to provide power from an external power source to the plurality of energy storage devices, and a controller including an electronic processor. The methods include determining, using the controller, which energy storage device in the plurality of energy storage device has a lowest state of charge, activating, using the controller, the energy storage device having the lowest state of charge to enable power flow from the external power source to the energy storage device having the lowest state of charge, and charging, using the controller, the energy storage device having the lowest state of charge for a first configurable amount of time. The methods further include determining, using the controller, whether any energy storage devices in the plurality of energy storage devices have a state of charge that is within a tolerance of the lowest state of charge, activating, using the controller, any energy storage devices in the plurality of energy storage devices having a state of charge that is within the tolerance of the lowest state of charge to enable power flow from the external power source to the energy storage devices having states of charge within the acceptable tolerance, and charging, using the controller, the energy storage device having the lowest state of charge and the energy storage devices having states of charge within the acceptable tolerance for a second configurable amount of time.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

Other aspects of the invention will become apparent by consideration of the detailed description and accompanying drawings.

### BRIEF DESCRIPTION OF THE DRAWINGS

FIG. 1A is a perspective view of a multi-bay battery pack system, illustrated with battery packs attached.

FIG. 1B illustrates a perspective view of the multi-bay battery pack system of FIG. 1A, illustrated with no battery packs attached.

FIG. 2 illustrates a user interface on the front of the multi-bay battery pack system of FIG. 1, according to embodiments described herein.

FIG. 3 is a perspective view of a battery pack to power the multi-bay battery pack system of FIG. 1, according to embodiments described herein.

FIG. 4 is a perspective view of a multi-bay battery system, according to some embodiments herein.

FIG. 5 is a perspective view of a single cell rechargeable battery to power the multi-bay battery system of FIG. 4, according to embodiments described herein.

FIG. 6 illustrates a control system for a multi-bay power supply.

FIG. 7 illustrates a schematic diagram of the multi-bay battery pack system of FIG. 1 or the multi-bay battery system of FIG. 4.

FIG. 8 is a process for discharging the multi-bay battery pack system of FIG. 1 or the multi-bay battery system of FIG. 4.

FIG. 9 is a process for charging the multi-bay battery pack system of FIG. 1 or the multi-bay battery system of FIG. 4.

FIG. 10 illustrates a schematic diagram of the multi-bay battery pack system of FIG. 1 or the multi-bay battery system of FIG. 4 including a plurality of ideal diodes and an ideal diode controller.

FIG. 11 illustrates an ideal diode and the ideal diode controller of FIG. 10.

### DETAILED DESCRIPTION

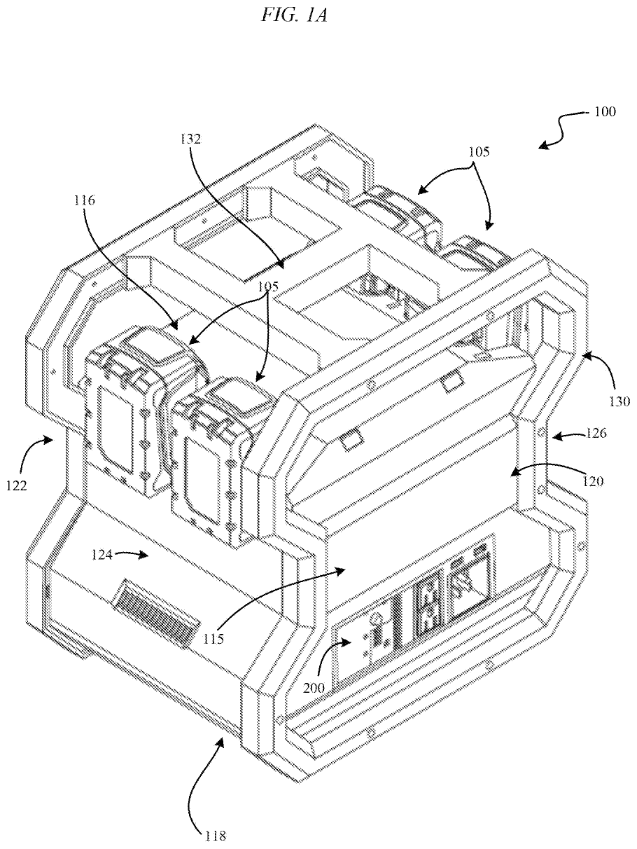

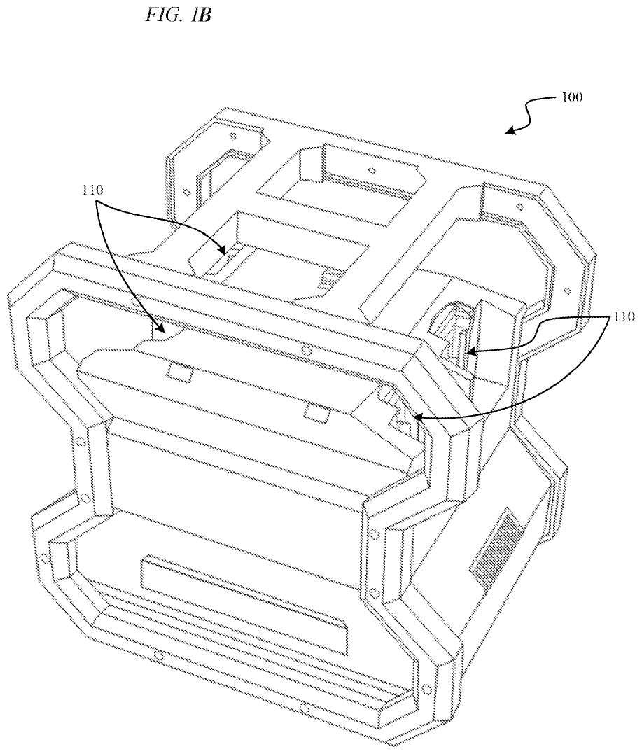

FIGS. 1A-1B illustrate a multi-bay battery pack system or multi-bay power supply 100 according to some embodiments. The multi-bay battery pack system 100 is operable to provide power to different electronic devices, such as power tools, outdoor tools, and other power equipment (e.g., lights, chargers for cordless batteries, heated articles of clothing). The multi-bay battery pack system 100 is powered by one or more battery packs or energy storage devices 105, which are received by one or more battery pack or energy storage device bays 110 provided on and/or disposed within a housing 115 of the multi-bay battery pack system 100. For each battery pack 105 (four in the illustrated construction), a battery pack bay 110 is provided on and/or disposed within the housing 115. Each battery pack 105 is electrically connected and removably coupled to a respective battery pack bay 110 and may be electrically connected in a series and/or parallel relationship with the other battery packs 105. Although the multi-bay battery pack system 100 is illustrated as supporting four battery packs 105 and four battery pack bays 110, it should be understood that the multi-bay battery pack system 100 may be powered by any number of battery packs 105 that are desired. For example, the multi-bay battery pack system 100 may support more or fewer than four battery packs 105 and battery pack bays 110.

The housing 115 of the illustrated multi-bay battery pack system 100 includes a top 116, a bottom 118, a front 120, a rear 122, and opposite sides 124, 126. A frame 130 is connected to the housing 115. A handle 132 is connected to portions of the frame 130, and the handle 132 may include elastomeric material to improve gripping, comfort of a user during movement of the multi-bay battery pack system 100, etc. Rubber feet may be fixed on the bottom 118 of the housing 115 (e.g., covering the corners), on the frame 130, etc. The feet provide a non-slip, non-scratch surface when the multi-bay battery pack system 100 is placed on a surface, such as a floor at a work site.

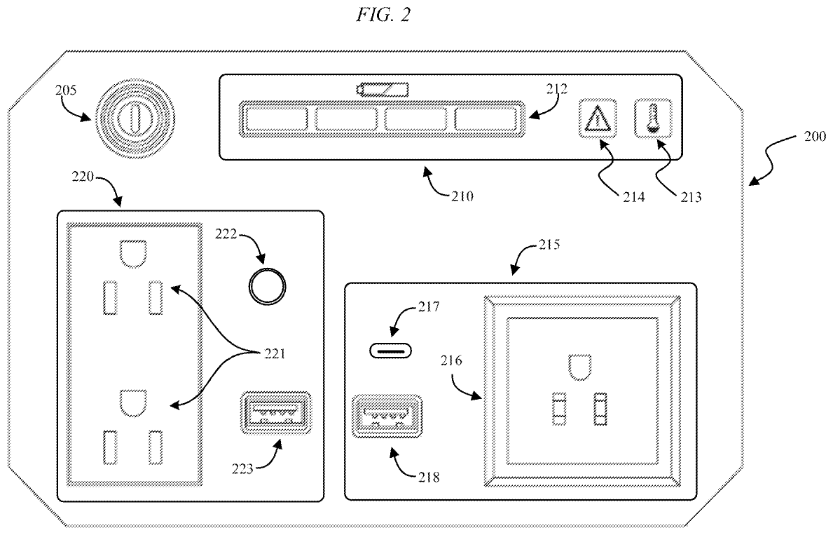

FIG. 2 illustrates a user interface 200 provided on the front 120 of the housing 115. In the illustrated example, the user interface 200 includes a power button 205, a display 210, a power input panel 215, and a power output panel 220. The power button 205 may be implemented as a pushbutton, a two-way switch, a touch button, etc. The power button 205 is used to control power output to the user interface 200 and can be activated to turn the multi-bay battery pack system 100 ON or OFF. When the power button 205 is used to turn ON the multi-bay battery pack system 100, power output through the power output panel 220 and the display 210 are enabled. When the power button 205 is used to turn OFF the multi-bay battery pack system 100, power output through the power output panel 220 and the display 210 are disabled. However, power input through the power input panel 215 is still enabled.

The display 210 is configured to indicate a state of the multi-bay battery pack system 100 to a user. The display 210 may be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In the illustrated embodiment, the display 210 includes a fuel gauge 212, an over-temperature indicator 213, and an overload indicator 214. The fuel gauge 212 is configured to display a state of charge of the one or more battery packs 105 connected to the multi-bay battery pack system 100. The over-temperature indicator 213 is activated when a temperature of the multi-bay battery pack system 100 or batteries 105 exceed a predetermined temperature threshold. The overload indicator 214 is activated when a load output of the multi-bay battery pack system 100 exceeds a predetermined load threshold. In some embodiments, the display 210 includes more or fewer indicators than the illustrated embodiment.

In the illustrated embodiment, the power input panel 215 includes multiple electrical connection interfaces, such as, but not limited to, AC inlet 216, USB-C port 217, and USB-A port 218. In some embodiments, the power input panel 215 includes additional electrical connection interfaces that are not illustrated in FIG. 2. The electrical connection interfaces are configured to receive power from an external power source. In some embodiments, the external power source may be a DC power source, for example, a photovoltaic cell (e.g., a solar panel), or the power source may be an AC power source, for example, a conventional wall outlet. In some embodiments, the power input panel 215 is replaced by or additionally includes a cable configured to plug into a conventional wall outlet. The power received by power input panel 215 is used to charge the battery packs 105 that are electrically connected to the respective battery pack bays 110 of multi-bay battery pack system 100.

The power output panel 220 includes one more power outlets. In the illustrated embodiment, the power output panel 220 includes a plurality of AC power outlets 221, a DC connection jack 222, and a USB-A port 223. It should be understood that number of power outlets included in power output panel 220 is not limited to the power outlets illustrated in FIG. 2. For example, in some embodiments of the multi-bay battery pack system 100, the power output panel 220 includes more or fewer power outlets than the power outlets included in the illustrated embodiment of multi-bay battery pack system 100. The power output panel 220 is configured to provide power from the battery packs 105 to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output panel 220. In addition, the peripheral devices may be configured to receive DC power from USB-C port 217 and USB-A port 218, which are included in power input panel 215.

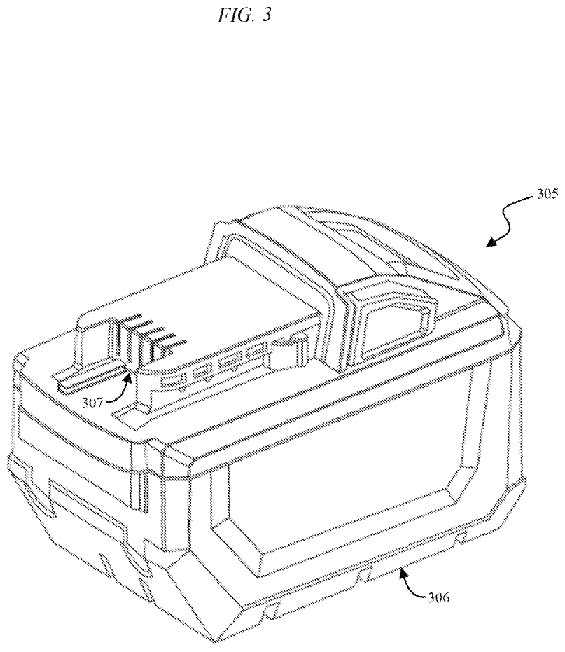

FIG. 3 illustrates an embodiment of the battery pack 105 in which the battery pack 105 is a rechargeable battery pack 305. The rechargeable battery pack 305 includes a housing 306 supporting one or more cells. Battery pack terminals 307 electrically connect the battery cells to the multi-bay battery pack system 100 through terminals included in the battery pack bays 110. Battery pack terminals 307 may include power terminals operable to transfer power between the rechargeable battery pack 305 and the multi-bay battery pack system 100 and communication terminals operable to transmit information between the rechargeable battery pack 305 and the multi-bay battery pack system 100.

The rechargeable battery pack 305 includes one or more cells arranged in cell strings, each having a number of battery cells (e.g., five battery cells) connected in series, parallel, or a series-parallel combination to provide a desired output discharge voltage (e.g., a nominal voltage [e.g., 12 V, 18 V, 20 V, 24 V, 40 V, 60 V, 80 V, 120 V, etc.] and current capacity). The rechargeable battery packs 305 may include a number of cell strings connected in parallel (e.g., two cell strings “5S2P”, three cell strings “5S3P”, etc.). In other embodiments, other combinations (series, parallel, combination series-parallel configurations) of battery cells are also possible.

Each battery cell may have a nominal voltage between 1 V and 5 V and a nominal capacity between about 1 Ah and about 5 Ah or more (e.g., up to about 9 Ah). The battery cells may be any rechargeable battery cell chemistry type, such as, for example Lithium (“Li”), Lithium-ion (“Li-ion”), other Lithium-based chemistry, Nickel-Cadmium (“NiCd”), Nickel-metal Hydride (“NiMH)”, etc.

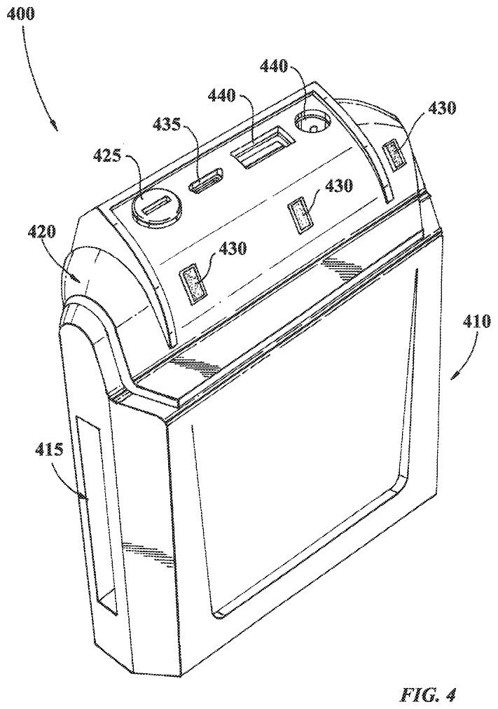

FIG. 4 illustrates a multi-bay battery or energy storage device system 400 according to another embodiment. The multi-bay battery system 400 is operable to provide power to different corded devices, such as power tools, outdoor tools, and other power equipment (e.g., lights, chargers for cordless batteries, heated articles of clothing, etc.). The multi-bay battery system 400 is powered by one or more batteries or energy storage devices, which are received by one or more battery or energy storage device bays (not shown) disposed within a housing 410 of the multi-bay battery system 400. In particular, the battery bays are disposed within a bottom portion 415 of the housing 410 and can be accessed by removing a top portion 420 of the housing 410. In some embodiments, the top portion 420 is pivotably fixed to the bottom portion 415 about an axis of rotation, such that the top portion 420 can be rotated to access the battery bays disposed within the bottom portion 415 of housing 410. In some embodiments, the top portion 420 cannot be removed from the back portion of the housing. In such embodiments, the battery bays can be accessed by a removing a panel disposed on the backside of housing 410.

In the illustrated example, the top portion 420 includes a power button 425, a display 430, a power input panel 435, and a power output panel 440. The power button 425 may be implemented as a pushbutton, a two-way switch, a touch button, etc. The power button 425 is used to control power output and can be activated to turn the multi-bay battery system 400 ON or OFF. When the power button 425 is used to turn ON the multi-bay battery system 400, power output through the power output panel 440 and the display 430 are enabled. When the power button 425 is used to turn OFF the multi-bay battery system 400, power output through the power output panel 440 and the display 430 is disabled. However, power input through the power input panel 435 is still enabled.

The display 430 is configured to indicate a state of the multi-bay battery system 400 to a user. In the illustrated embodiment, the display 430 includes three indicators that are configured to display a state of the batteries 105 disposed within the multi-bay battery system 400. The display 430 may be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In some embodiments, the display 430 includes more or fewer indicators than the illustrated embodiment.

In the illustrated embodiment, the power input panel 435 includes a USB-C port. In some embodiments, the power input panel 435 includes multiple electrical connection interfaces, such as, but not limited to, AC inlets and USB-A ports. The power input panel 435 is configured to receive power from an external power source. In some embodiments, the external power source may be a DC power source, for example, a photovoltaic cell (e.g., a solar panel), or the power source may be an AC power source, for example, a conventional wall outlet. The power received by power input panel 435 is used to charge the batteries 105 that are electrically connected to the respective battery bays disposed within the multi-bay battery system 400.

In the illustrated embodiment, the power output panel 440 includes a DC connection jack and a USB-A port. In some embodiments of the multi-bay battery system 400, the power output panel 440 may include more or fewer power outlets than the power outlets included in the illustrated embodiment of multi-bay battery system 400. The power output panel 440 is configured to provide power from the batteries to one or more peripheral devices. For example, the DC connection jack may be used provide power to one or more heated articles of clothing, such as a heated jacket. The one or more peripheral devices may also include a smartphone, a tablet computer, a laptop computer, a portable music player, a power tool, a power tool battery pack, a power tool battery pack charger, or the like. The peripheral devices may also be configured to receive DC power from the USB-C port included in the power input panel 435.

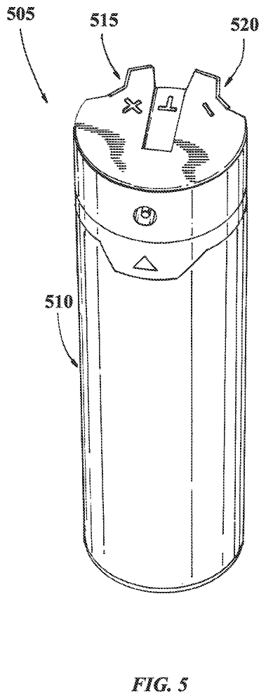

FIG. 5 illustrates an embodiment of a single cell rechargeable battery or energy storage device 505. The single cell rechargeable battery 505 is enclosed in a cylindrical housing 510. The cylindrical housing 510 includes a positive terminal 515 and a negative terminal 520 for electrically connecting the single cell rechargeable battery 505 to the multi-bay battery system 400. In some embodiments, the terminals are implemented as a USB port and cable. The single cell rechargeable battery 505 may have a nominal voltage between 1 V and 5 V and a nominal capacity between about 1 Ah and about 15 Ah or more. The single cell rechargeable battery 505 may be any chemistry type, such as, for example Lithium (“Li”), Lithium-ion (“Li-ion”), other Lithium-based chemistry, Nickel-Cadmium (“NiCd”), Nickel-metal Hydride (“NiMH)”, etc.

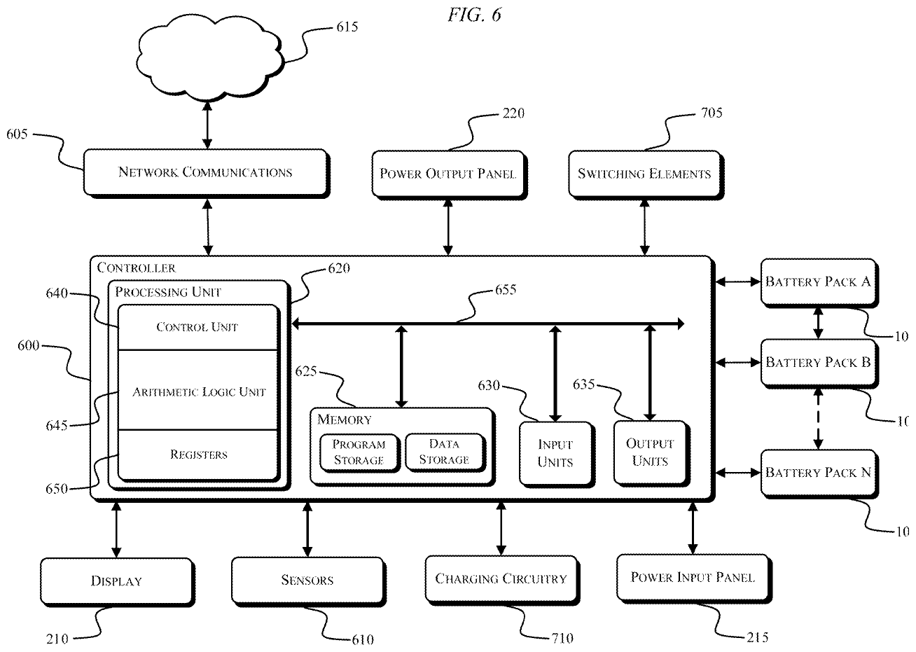

FIG. 6 is a generalized schematic illustration of the controller 600 of a multi-bay power supply, such as the multi-bay battery pack system 100 or the multi-bay battery system 400. Although it should be understood that the controller 600 could be included in the multi-bay battery pack system 100 or the multi-bay battery system 400, the controller 600 will be described with respect to the components included in multi-bay battery pack system 100. The controller 600 is electrically and/or communicatively connected to a variety of modules or components of the multi-bay battery pack system 100. For example, the illustrated controller 600 is connected to the battery packs 105A-105N, the power button 205, the display 210, the power input panel 215, and the power output panel 220. The electrical and/or communicative connection between the controller 600 and battery pack 105A (as well as battery packs 105B-105N) includes electrical and/or communicative connection between the controller 600 and components of battery pack 105A, such as, but not limited to, the battery cells or sensors included in the battery pack 105A.

The controller 600 is additionally electrically and/or communicatively connected to a network communications module 605, a plurality of sensors 610, a plurality of switching elements 705, and charging circuitry 710. The network communications module 605 is connected to a network 615 to enable the controller 600 to communicate with peripheral devices in the network, such as a smartphone or a server. The sensors 610 include, for example, one or more voltage sensors, one or more current sensors, one or more temperature sensors, etc. Each of the sensors 610 generates one or more output signals that are provided to the controller 600 for processing and evaluation.

The controller 600 includes combinations of hardware and software that are operable to, among other things, control the operation of the multi-bay battery pack system 100, communicate over the network 615, receive input from a user via the user interface 200, provide information to a user via the display 210, etc. For example, the controller 600 includes, among other things, a processing unit 620 (e.g., a microprocessor, a microcontroller, an electronic processor, an electronic controller, or another suitable programmable device), a memory 625, input units 630, and output units 635. The processing unit 620 includes, among other things, a control unit 640, an arithmetic logic unit (“ALU”) 645, and a plurality of registers 650 (shown as a group of registers in FIG. 6), and is implemented using a known computer architecture (e.g., a modified Harvard architecture, a von Neumann architecture, etc.). The processing unit 620, the memory 625, the input units 630, and the output units 635, as well as the various modules or circuits connected to the controller 600 are connected by one or more control and/or data buses (e.g., common bus 655). The control and/or data buses are shown generally in FIG. 6 for illustrative purposes. Although the controller 600 is illustrated in FIG. 6 as one controller, the controller 600 could also include multiple controllers configured to work together to achieve a desired level of control for the multi-bay battery pack system 100. As such, any control functions and processes described herein with respect to the controller 600 could also be performed by two or more controllers functioning in a distributed manner.

The memory 625 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 620 is connected to the memory 625 and is configured to execute software instructions that are capable of being stored in a RAM of the memory 625 (e.g., during execution), a ROM of the memory 625 (e.g., on a generally permanent basis), or another non-transitory computer readable medium such as another memory or a disc. Software included in the implementation of the multi-bay battery pack system 100 and controller 600 can be stored in the memory 625 of the controller 600. The software includes, for example, firmware, one or more applications, program data, filters, rules, one or more program modules, and other executable instructions. The controller 600 is configured to retrieve from the memory 625 and execute, among other things, instructions related to the control processes and methods described herein. In other embodiments, the controller 600 includes additional, fewer, or different components.

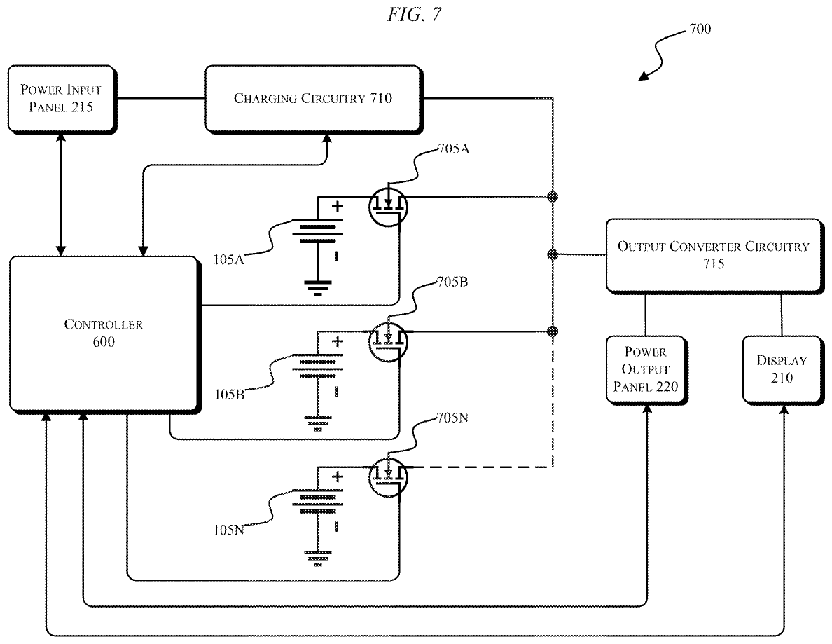

FIG. 7 is a generalized schematic illustration of the multi-bay power supply 700. Although it should be understood that the generalized schematic view illustrated by FIG. 7 is representative of multi-bay battery pack system 100 and multi-bay battery system 400 (including single cell rechargeable battery 505), the generalized schematic view will be described with respect to the components included in multi-bay battery pack system 100. As shown in FIG. 7, the multi-bay battery pack system 100 includes a plurality of battery packs 105A-105N. Although only one battery pack 105 is needed to operate the multi-bay battery pack system 100, the multi-bay battery pack system 100 may include any desired number, N, of battery packs 105A-105N.

The battery packs 105A-105N are illustrated as being selectively connected in parallel between either the charging circuitry 710 and/or converter circuitry 715 and ground. In particular, an individual battery pack 105 is electrically connected to the charging circuitry 710 and/or converter circuitry 715 by a respective switching element 705. The controller 600 is configured to electrically connect/disconnect an individual battery pack 105 to the charging circuitry 710 and/or converter circuitry 715 by controlling the respective switching element 705 that is connected to the individual battery pack 105. Although illustrated as being electrically connected in parallel, the battery packs 105A-105N may be electrically connected in series, in parallel, and/or a combination thereof.

The combined power output of one or more of the battery packs 105A-105N is provided by the converter circuitry 715 to the power output panel 220 for powering the one or more peripheral devices. The converter circuitry 715 may include an inverter for converting DC voltage supplied by one or more of the battery packs 105A-105N to AC voltage for powering peripheral devices connected to AC outlets of the power output panel 220. For example, if the battery packs 105A-105N are implemented as rechargeable battery packs 305, the inverter converts the battery pack voltage to a 120V AC voltage (e.g., conventional AC power provided by a wall outlet). The inverted 120V AC voltage is provided to one or more peripheral devices connected to the AC power outlets 221 of power output panel 220. The converter circuitry 715 may additionally include DC-DC converters that buck and/or boost the DC voltage provided by one or more of the battery packs 105A-105N to the one or more peripheral devices electrically connected to power output panel 220.

As further shown in FIG. 7, the battery packs 105A-105N are electrically connected to the power input panel 215 by the charging circuitry 710. The charging circuitry 710 may include a rectifier for converting AC power supplied by an external power source to DC power for charging the battery packs 105A-105N. For example, if the battery packs 105 are implemented as rechargeable battery packs 305 each having a nominal voltage of 18V, the rectifier converts the 120V AC provided by a conventional wall outlet to 18V DC. The 18V DC is provided to the battery packs 105A-105N for charging. The charging circuitry 710 may further include a DC-DC converter that bucks and/or boosts the DC voltage provided by an external DC power source to the one or more battery packs 105A-105N.

The multi-bay power supply is configured to operate in a discharging mode and a charging mode. Although it should be understood that both multi-bay battery pack system 100 and multi-bay battery system 400 are configured to operate in the above mentioned modes of operation, the modes of operation will be described with respect to the components included in multi-bay battery pack system 100 for illustrative purposes. During operation of the multi-bay battery pack system 100, the controller 600 reads the voltage value, or state of charge (SOC), of each of the battery packs 105A-105N connected to the multi-bay battery pack system 100. The sensed voltage values of battery packs 105A-105N are, for example, stored in the plurality of registers 650 included in processing unit 620 of controller 600. In some embodiments, the voltage values of battery packs 105A-105N are stored in the RAM of memory 625. The voltage values of battery packs 105A-105N may be updated in a continuous, or periodic, manner. For example, the controller 600 is configured to read an updated voltage value of battery pack 105A at a selectable or configurable sampling rate, such as 1 Hz.

When operating in a discharging mode of operation, the controller 600 is configured to selectively provide power from one or more battery packs 105A-105N to one or more peripheral devices connected to the power output panel 220. For example, while operating in a discharging mode of operation, two or more of the battery packs 105A-105N may be discharged in series or in parallel to provide power to a power tool (e.g., a circular saw) that is electrically connected to power output panel 220. Discharging two or more of the battery pack 105A-105N in series or in parallel enables a large amount of power to be provided to the power tool for an extended period of time. In some embodiments, the peripheral device is a power tool that is not electrically connected to the power output panel. In such embodiments, the power tool is configured to directly receive two or more battery packs 105. The power tool includes a controller having an electronic processor that is configured to discharge the two or more battery packs 105 in parallel using the balanced discharging processes described below.

During the discharging mode of operation, the controller 600 determines which of the battery packs 105A-105N has the highest state of charge and provides power from the battery pack 105 having the highest state of charge to the one or more peripheral devices for a configurable amount of time. For example, if the battery packs 105A-105C are rechargeable battery packs 305 having respective voltages of 18V, 17.8V, and 17.5V, battery pack 105A has the highest state of charge. Accordingly, the controller 600 turns on switching element 705A, while keeping switching elements 705B and 705C off, to enable power to be delivered from battery pack 105A to the one or more peripheral devices. In some embodiments, the configurable amount of time is a user configurable amount, such as 0.5 seconds. In some embodiments, the configurable amount of time is a function of the states of charge of battery packs 105A-105N.

After the battery pack 105 having the highest state of charge is discharged for the configurable amount of time, the controller 600 reads updated state of charge values for each of the battery packs 105A-105N. Based on the updated state of charge values, the controller 600 determines whether any battery packs 105A-105N have a state of charge that is within an acceptable threshold or tolerance of the highest state of charge. When determining whether any battery packs 105A-105N have a state of charge that is within the acceptable tolerance of the highest state of charge, the controller 600 is configured to calculate differences between the voltage values of battery packs 105A-105N and the voltage level of the battery pack 105 having the highest state of charge. In some embodiments, when determining whether any battery packs 105A-105N have a state of charge that is within the acceptable tolerance of the highest state of charge, the controller 600 is configured to calculate differences between the state of charge percentages of battery packs 105A-105N and the state of charge percentage of the battery pack 105 having the highest state of charge.

The calculated voltage differences are compared to the acceptable tolerance. The acceptable tolerance is an amount by which the state of charge of a particular battery pack 105A-105N can differ from the highest state of charge without being operated in a different manner than the battery pack 105 having the highest state of charge. The acceptable tolerance is a configurable value that may be stored in memory 625 of controller 600. In some embodiments, the acceptable tolerance is a scalar voltage value, such 0.5 volts. In other embodiments, the acceptable tolerance is a configurable percentage value. For example, the acceptable tolerance is a percentage difference between voltage values of battery packs 105A-105N and the voltage value of the battery pack 105 having the highest state of charge, such as 1%. In another example, the acceptable tolerance may be a configurable percentage value, such as 1%, of the highest state of charge. In such an example, any battery packs 105A-105N that have a state of charge that is within 1% of the highest state of charge are within the acceptable tolerance.

The controller 600 is configured to activate any battery packs 105A-105N that have a voltage level within the acceptable tolerance of the highest state of charge by turning on the corresponding switching elements 705A-705N. Thus, any battery packs 105A-105N that have a state of charge within the acceptable tolerance, including the battery pack 105 having the highest state of charge, are discharged to provide power to peripheral devices connected to power output panel 220. The respective switching elements 705A-705N of any battery packs 105A-105N that do not have states of charge within the acceptable tolerance are kept off. Therefore, the battery packs 105A-105N that have states of charge outside of the acceptable tolerance are not discharged to provide power to the one or more peripheral devices.

The battery pack 105 having the highest state of charge and battery packs 105A-105N that have a state of charge within the acceptable tolerance are discharged for a second configurable amount of time. The second configurable amount of time may be the same as or different from the amount of time for which the battery pack 105 having the highest state of charge was discharged by itself. After the second configurable amount of time passes, the controller 600 reads updated state of charge values for each of the battery packs 105A-105N. The above described balanced discharge process may be repeated for as long as the multi-bay battery pack system 100 operates in the discharging mode of operation. Additionally or alternatively, the above described balanced discharge process may be repeated until the battery packs 105A-105N are no longer capable of providing power to the one or more peripheral devices connected to the output panel 220.

With reference to the example provided above in which the voltage levels of battery packs 105A-105C are 18V, 17.8V, and 17.5V respectively, the controller 600 determined that battery pack 105A has the highest state of charge. Accordingly, the controller 600 turned on switching element 705A, while keeping switching elements 705B and 705C off, to provide power from battery pack 105A to the one or more peripheral devices for the configurable amount of time. After battery pack 105A is discharged for the configurable amount of time (for example, 0.5 seconds), the controller 600 reads updated voltage values of battery packs 105A-105C to determine whether battery pack 105B or 105C has a state of charge that is within an acceptable tolerance of the state of charge of battery pack 105A.

For exemplary purposes, it will be assumed that the acceptable tolerance is equal to 0.3V, and the voltage of battery pack 105A dropped to 17.9V after being discharged for the configurable amount of time. Accordingly, the controller 600 determines that the voltage of battery pack 105B, 17.8V, is within the acceptable tolerance. The controller 600 further determines that the voltage of battery pack 105C, 17.5V, is not within the acceptable tolerance. Accordingly, the controller 600 turns on switching element 705B such that battery packs 105A and 105B are discharged for the second configurable amount of time to provide power to the one or more peripheral devices. For exemplary purposes, if it is assumed that the voltages of battery packs 105A and 105B each drop by 0.3V when being discharged for the second configurable amount of time, the controller 600 will determine that the update voltage values of battery packs 105A-105C are 17.6V, 17.5V, and 17.5V respectively. Therefore, during the next cycle of the balanced discharge process, the controller 600 will turn on switching element 705C. Accordingly, battery packs 105A-105C will be simultaneously discharged for the second configurable amount of time to provide power to the one or more peripheral devices.

Although the above example is provided with respect to a multi-bay battery pack system 100 that includes three battery packs 105A-105C, the controller 600 may perform the balanced discharge process for the multi-bay battery pack system 100 having any number of battery packs 105A-105N. In addition, even though the acceptable tolerance is described above as being a scalar voltage value of 0.3V, the acceptable tolerance may be any scalar voltage value that is desired. Furthermore, the acceptable tolerance may be a percentage of the highest state of charge or voltage level. For example, the acceptable tolerance may be equal to 3% of the highest state of charge or voltage value. Therefore, if the battery pack 105 having the highest state of charge has a voltage level of 18V, batteries having a voltage of 17.46V or greater are within the acceptable tolerance.

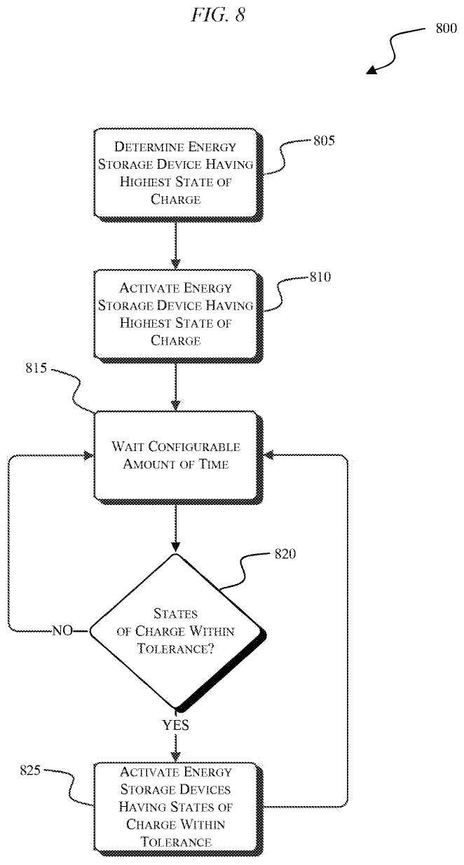

FIG. 8 is flowchart illustrating a process 800 for balanced discharging of a plurality batteries or battery packs during a discharging mode of operation of a multi-bay power supply. For descriptive purposes, batteries and battery packs will be described generally as energy storage devices. It should be understood that the order of steps disclosed in process 800 can vary from the order illustrated in FIG. 8. The process 800 begins with the controller 600 determining which of the plurality of energy storage devices has the highest state of charge (STEP 805). The controller 600 is then configured to activate the energy storage device that has the highest state of charge. As described above with respect to FIG. 7, the controller 600 is configured to activate power flow from the energy storage device having the highest state of charge to the one or more peripheral devices by turning on the respective switching element 705 (STEP 810). The controller 600 waits a configurable amount of time while power is provided to the one or more peripheral devices (STEP 815). After the configurable amount of time elapses, the controller 600 determines whether any energy storage devices have state of charge that is within an acceptable tolerance of the state of charge of the energy storage device having the highest state of charge (STEP 820). If, at STEP 820, the controller 600 determines that none of the other energy storage devices have a state of charge that is within the acceptable tolerance of the highest state of charge, the process returns to STEP 815 where the controller 600 is configured to provide power from the activated energy storage devices to the one or more peripheral devices. If, at STEP 820, the controller 600 determines that one or more energy storage devices have a state of charge that is within the acceptable tolerance of the highest state of charge, the controller 600 is configured to activate the energy storage devices that have a state of charge within the acceptable range. As described above with respect to FIG. 7, the controller 600 is configured to activate power flow from energy storage devices having a state of charge within the acceptable tolerance by turning on the respective switching elements 705A-705N (STEP 825). The process returns to STEP 815 where the controller 600 is configured to provide power from the activated energy storage devices to the one or more peripheral devices. The balanced discharge process 800 is repeated for as long as the multi-bay power supply operates in the discharging mode of operation. Additionally or alternatively, the balanced discharge process 800 may be repeated until the energy storage devices are no longer capable of providing power to the one or more peripheral devices connected to the output panel 220.

When operating in a charging mode of operation, the controller 600 is, for example, configured to selectively provide power from one or more external power sources connected to the power input panel 215 to a plurality of battery packs 105A-105N connected to the multi-bay battery pack system 100. For example, the multi-bay battery pack system 100 may be used as a charger bank for charging battery packs 105A-105N with a single charging circuit 710.

During the charging mode of operation, the controller 600 determines which of the battery packs 105A-105N has the lowest state of charge and provides power from the one or more external power sources to the lowest state of charge battery pack 105 for a configurable amount of time. For example, if the battery packs 105A-105C are rechargeable battery packs 305 having respective voltages of 18V, 17.8V, and 17.5V, battery pack 105C has the lowest state of charge. Accordingly, the controller 600 turns on switching element 705C, while keeping switching elements 705A and 705B off, to enable power to be delivered from the one or more external power sources to the lowest state of charge battery pack 105C. In some embodiments, the configurable amount of time is a user configurable amount, such as 0.5 seconds. In some embodiments, the configurable amount of time is a function of the states of charge of battery packs 105A-105N.

After the battery pack 105 having the lowest state of charge is charged for the configurable amount of time, the controller 600 reads updated state of charge values for each of the battery packs 105A-105N. Based on the updated state of charge values, the controller 600 determines whether any battery packs 105A-105N have a state of charge that is within an acceptable tolerance of the lowest state of charge. When determining whether any battery packs 105A-105N have a state of charge that is within the acceptable tolerance of the lowest state of charge, the controller 600 is configured to calculate differences between the voltage values of battery packs 105A-105N and the voltage level of the battery pack 105 having the lowest state of charge. In some embodiments, when determining whether any battery packs 105A-105N have a state of charge that is within the acceptable tolerance of the lowest state of charge, the controller 600 is configured to calculate differences between the voltage values of battery packs 105A-105N and the voltage level of the battery pack 105 having the lowest state of charge.

The calculated voltage differences are compared to the acceptable tolerance. The acceptable tolerance is an amount by which the state of charge of a particular battery pack 105A-105N can differ from the lowest state of charge without being operated in a different manner than the lowest state of charge battery pack 105. The acceptable tolerance is a configurable value that may be stored in memory 625 of controller 600. In some embodiments, the acceptable tolerance is a scalar voltage value, such 0.5 volts. In other embodiments, the acceptable tolerance is a configurable percentage value. For example, the acceptable tolerance is a percentage difference between voltage values of battery packs 105A-105N and the voltage value of the battery pack 105 having the lowest state of charge, such as 1%. In another example, the acceptable tolerance may be a configurable percentage value, such as 1%, of the lowest state of charge. In such an example, any battery packs 105A-105N that have a state of charge that is within 1% of the lowest state of charge are within the acceptable tolerance.

The controller 600 is configured to activate any battery packs 105A-105N that have a voltage level within the acceptable tolerance of the lowest state of charge by turning on the corresponding switching elements 705A-705N. Thus, any battery packs 105A-105N that have a state of charge within the acceptable tolerance, including the battery pack 105 having the lowest state of charge, are charged by the one or more external power sources connected to power input panel 215. The respective switching elements 705A-705N of any battery packs 105A-105N that do not have states of charge within the acceptable tolerance are kept off. Therefore, the battery packs 105A-105N that have states of charge outside of the acceptable tolerance are not provided charging power from the one or more external power sources.

The battery pack 105 having the lowest state of charge and battery packs 105A-105N that have a state of charge within the acceptable tolerance are simultaneously charged for a second configurable amount of time. The second configurable amount of time may be the same as or different from the amount of time for which the battery pack 105 having the lowest state of charge was charged by itself. After the configurable amount of time passes, the controller 600 reads updated state of charge values for each of the battery packs 105A-105N. The above described balanced charge process may be repeated for as long as the multi-bay battery pack system 100 operates in the charging mode of operation. Alternatively, or in addition, the above described balanced charge process may be repeated until the battery packs 105A-105N are charge to full capacity.

With reference to the example provided above in which the voltage levels of battery packs 105A-105C are 18V, 17.8V, and 17.5V respectively, the controller 600 determined that battery pack 105C has the lowest state of charge. Accordingly, the controller 600 turned on switching element 705C, while keeping switching elements 705A and 705B off, to provide power from the one or more external power sources to battery pack 105C for the configurable amount of time. After battery pack 105C is charged for the configurable amount of time (for example, 0.5 seconds), the controller 600 reads updated voltage values of battery packs 105A-105C to determine whether battery pack 105A or 105B has a state of charge that is within an acceptable tolerance of the state of charge of battery pack 105C.

For illustrative purposes, it will be assumed that the acceptable tolerance is equal to 0.3V, and the voltage of battery pack 105C increased to 17.6V after being charged for the configurable amount of time. Accordingly, the controller 600 determines that the voltage of battery pack 105B, 17.8V, is within the acceptable tolerance. The controller 600 further determines that the voltage of battery pack 105A, 18V, is not within the acceptable tolerance. The controller 600 turns on switching element 705B such that battery packs 105B and 105C are charged by the one or more external power sources for the second configurable amount of time (for example, 1 minute). For exemplary purposes, if it is assumed that the voltages of battery packs 105B and 105C each increase by 0.3V when being charged for the configurable amount of time, the controller 600 will determine that the updated voltage values of battery packs 105A-105C are 18V, 18.1V, and 17.9V respectively. Therefore, during the next cycle of the balanced charge process, the controller 600 will turn on switching element 705A. Accordingly, battery packs 105A-105C will be simultaneously charged from power provided by the one or more external power sources.

Although the above example is provided with respect to a multi-bay battery pack system 100 that includes three battery packs 105A-105C, the controller 600 may perform the balanced discharge process for a multi-bay battery pack system 100 having any number of battery packs 105A-105N. In addition, even though the acceptable tolerance is described above as being a scalar voltage value of 0.3V, the acceptable tolerance may be any scalar voltage value that is desired. Furthermore, persons skilled in the art will appreciate that the acceptable tolerance may be a percentage of the highest state of charge or voltage level. For example, the acceptable tolerance may be equal to 1% of the lowest state of charge or voltage value. Therefore, if the battery pack 105 having the lowest state of charge has a voltage level of 17.5V, battery packs having a voltage of 17.65V or less are within the acceptable tolerance.

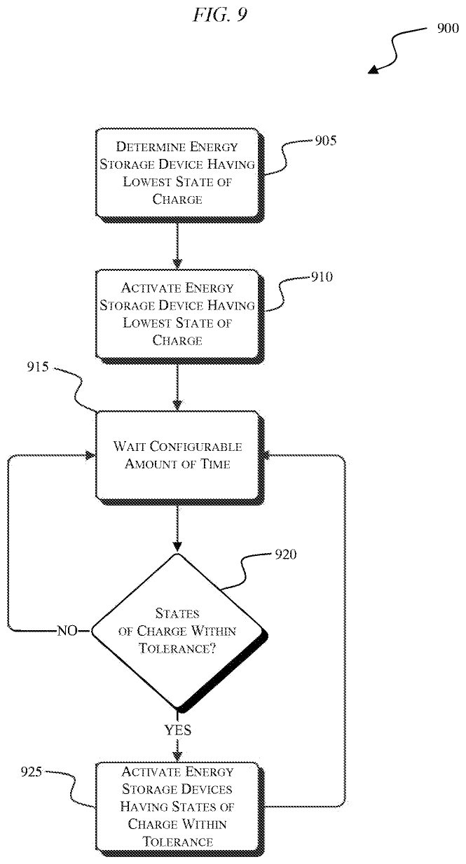

FIG. 9 is flowchart illustrating a process 900 for balanced charging of a plurality batteries or battery packs during a charging mode of operation of the multi-bay power supply. For descriptive purposes, batteries and battery packs will be described generally as energy storage devices. It should be understood that the order of steps disclosed in process 900 can vary from the order illustrated in FIG. 9. The process 900 begins with the controller 600 determining which of the plurality of energy storage devices has the lowest state of charge (STEP 905). The controller 600 is then configured to activate the energy storage device that has the lowest state of charge. As described above with respect to FIG. 7, the controller 600 is configured to activate power flow from an external power source connected to a power input panel to the battery 105 having the lowest state of charge by turning on the respective switching element 705 (STEP 910). The controller 600 waits a configurable amount of time while the one or more activated energy storage devices are charged (STEP 915). After the configurable amount of time elapses, the controller 600 determines whether any energy storage devices have state of charge that is within an acceptable tolerance of the state of charge of the energy storage device having the lowest state of charge (STEP 920). If, at STEP 920, the controller 600 determines that none of the energy storage devices have a state of charge that is within the acceptable tolerance of the lowest state of charge, the process returns to STEP 915 where the controller 600 is configured to provide power from the external power source to the activated energy storage devices. If, at STEP 920, the controller 600 determines that one or more energy storage devices have a state of charge that is within the acceptable tolerance of the lowest state of charge, the controller 600 is configured to activate the energy storage devices that have a state of charge within the acceptable range. As described above with respect to FIG. 7, the controller 600 is configured to activate power flow from the external power source to the energy storage devices having a state of charge within the acceptable tolerance by turning on the respective switching elements 705A-705N (STEP 925). The process returns to STEP 915 where the controller 600 is configured to provide power from the external power source to the activated energy storage devices. The balanced charge process 900 is repeated for as long as the multi-bay battery pack system 100 operates in the charging mode of operation. Additionally or alternatively, the balanced charge process 900 may be repeated until the energy storage devices are charge to full capacity.

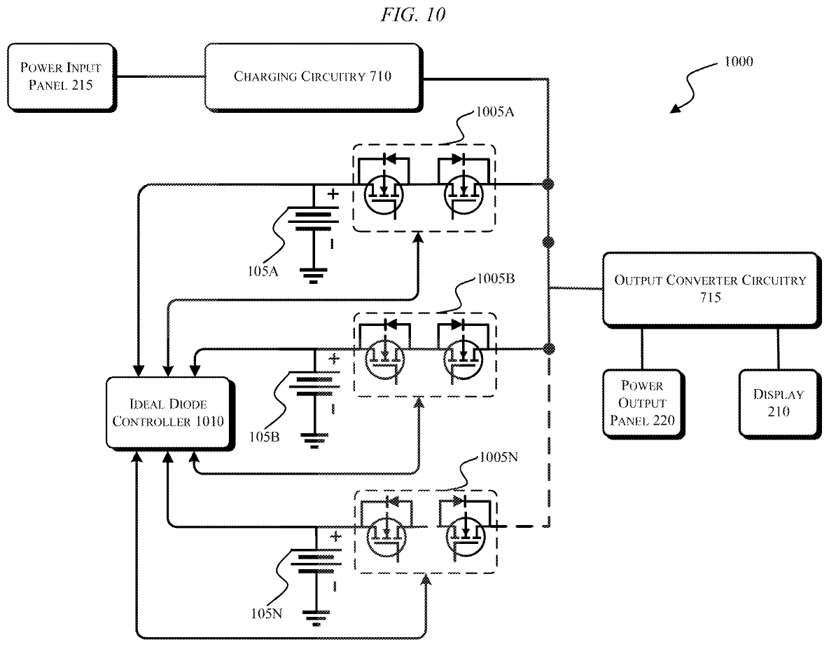

FIG. 10 is a generalized schematic illustration of a multi-bay power supply 1000, a variation of the multi-bay power supply described above. Although it should be understood that the multi-bay power supply 1000 may be implemented with components included in the multi-bay battery pack system 100 and/or components included the multi-bay battery system 400 (including single cell rechargeable battery 505), the multi-bay power supply 1000 will be described with respect to the components included in multi-bay battery pack system 100. As will be described in more detail below, the multi-bay power supply 1000 is a generally hardware-based implementation of the software controlled multi-bay power supply systems described above.

As shown in FIG. 10, the multi-bay power supply 1000 includes a plurality of battery packs 105A-105N. Although only one battery pack 105 is needed to operate the multi-bay power supply 1000, the multi-bay power supply 1000 may include any desired number, N, of battery packs 105A-105N. The battery packs 105A-105N are illustrated as being selectively connected in parallel between either the charging circuitry 710 and/or converter circuitry 715 and ground. In particular, an individual battery pack 105 is electrically connected to the charging circuitry 710 and/or converter circuitry 715 by a respective ideal diode 1005.

The multi-bay power supply 1000 also includes an ideal diode controller 1010. The ideal diode controller 1010 is a hardware-based controller that includes, for example, logic circuits (e.g., potentially including AND gates, OR gates, NAND gates, operational amplifiers, etc.), configured to implement the software-based balanced charging and discharging methods described above. For example, the logic circuits of ideal diode controller 1010 include voltage comparators that are configured to determine relative differences between the states of charge of battery packs 105A-105N. As shown in FIG. 10, the DC voltage level of battery packs 105A-105N may be fed directly to the ideal diode controller 1010. Depending on the determined differences between the charge states of battery packs 105A-105N, the ideal diode controller 1010 is configured to apply ON and/or OFF gate signals to respective ideal diodes 1005A-1005N.

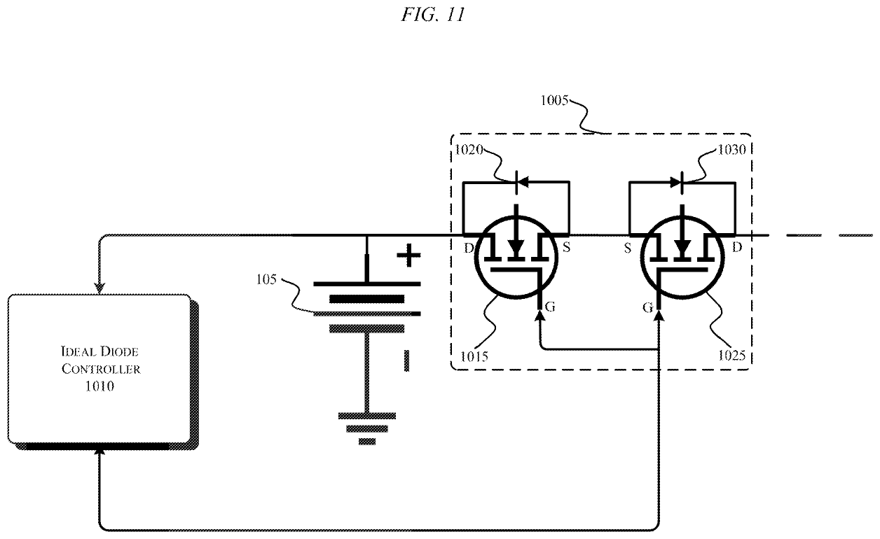

As shown in FIG. 11, an ideal diode 1005 includes a first switching element 1015 having a first body diode 1020 and a second switching element 1025 having a second body diode 1030. When a battery pack 105 connected in series with an ideal diode 1005 is being charged, current flows from the charging circuitry 710 to the battery pack 105 through the ideal diode 1005. For example, current flows from the drain to the source of the second switching element 1025 and through the first body diode 1020 on a path from the charging circuitry 710 to the battery pack 105. When a battery pack 105 connected in series with an ideal diode 1005 is being discharged, current flows from the battery pack 105 to the output converter circuitry 715 through the ideal diode 1005. In particular, current flows from the drain to source of the first switching element 1015 and through the second body diode 1030 on a path from the battery pack 105 to the charging circuitry. Although the switching elements included in ideal diode 1005 are illustrated as two N-channel MOSFETs connected in a source-to-source series connection, it should be understood that the ideal diode may include any combination of switching elements that enable the bidirectional flow of current, as described above. For example, the ideal diode may include two P-channel MOSFETs arranged in series, two IGBTs arranged in series, etc. In some embodiments, if bi-directional current flow is not required or desired, the ideal diodes may be replaced with standard diodes, power diodes, Schottky diodes, etc.

Similar to the multi-bay battery pack system 100 described above, the multi-bay power supply 1000 is configured to operate in a discharging mode and a charging mode. When operating in a discharging mode of operation, the logic circuits within ideal diode controller 1010 are configured to selectively turn on ideal diodes 1005A-1005N such that power is provided from one or more battery packs 105A-105N to one or more peripheral devices connected to the power output panel 220. In particular, with the use of hardware-based logic circuits, ideal diode controller 1010 of the multi-bay power supply 1000 is operable to perform the balanced discharging methods performed by controller 600 and described above. When operating in a charging mode of operation, the logic circuits within ideal diode controller 1010 are configured to selectively turn on ideal diodes 1005A-1005N such that power is provided from one or more external power sources connected to the power input panel 215 to the plurality of battery packs 105A-105N connected to the multi-bay power supply 1000. In particular, with the use of hardware-based logic circuits, ideal diode controller 1010 of the multi-bay power supply 1000 is operable to perform the balanced charging methods performed by controller 600 and described above. In some embodiments, the ideal diode controller 1010 can be replaced with the controller 600 described above. In such embodiments, the controller 600 is configured to control the ideal diodes 1005A-1005N during balanced charging and discharging operations.

Thus, embodiments described herein provide, among other things, a multi-bay power supply that includes balanced battery discharging and charging. Various features and advantages are set forth in the following claims.

What is claimed is:

1. A multi-bay power supply comprising:
a plurality of energy storage devices;
a power output configured to provide power from the plurality of energy storage devices to a peripheral device; and
a controller including an electronic processor configured to:
determine which energy storage device of the plurality of energy storage devices has a highest state of charge,
provide power to the peripheral device by discharging the energy storage device having the highest state of charge for a first configurable amount of time,
determine whether any energy storage devices in the plurality of energy storage devices have a state of charge that is within a tolerance of the highest state of charge, and
provide power to the peripheral device by discharging the energy storage device having the highest state of charge and any energy storage devices in the plurality of energy storage devices having the state of charge that is within the tolerance of the highest state of charge.

2. The multi-bay power supply of claim 1, wherein the energy storage device having the highest state of charge and the energy storage devices in the plurality of energy storage devices having states of charge that are within the tolerance of the highest state of charge are discharged for a second configurable amount of time.

3. The multi-bay power supply of claim 2, wherein the controller is further configured to read updated state of charge values of energy storage devices in the plurality of energy storage devices after the second configurable amount of time has passed.

4. The multi-bay power supply of claim 2, wherein the controller is configured to discharge the energy storage devices in the plurality of energy storage devices having the state of charge that is within the tolerance of the highest state of charge by turning on switching elements that are provided on respective current paths between the energy storage devices in the plurality of energy storage devices having the state of charge that is within the tolerance of the highest state of charge and the peripheral device.

5. The multi-bay power supply of claim 1, wherein the plurality of energy storage devices includes rechargeable power tool battery packs.

6. The multi-bay power supply of claim 1, wherein the controller is configured to discharge the energy storage device having the highest state of charge by turning on a switching element that is provided on a current path between the energy storage device having the highest state of charge and the peripheral device.

7. The multi-bay power supply of claim 1, wherein the peripheral device is a heated article of clothing.

8. The multi-bay power supply of claim 1, further comprising:
a plurality of energy storage device bays, wherein each of the plurality of energy storage devices is electrically connectable to a respective one of the plurality of energy storage device bays.

9. The multi-bay power supply of claim 8, wherein the plurality of energy storage device bays is disposed in a housing of the multi-bay power supply.

10. The multi-bay power supply of claim 1, wherein energy storage devices included in the plurality of energy storage devices are electrically connectable in parallel.

11. The multi-bay power supply of claim 1, wherein the tolerance is a percentage of the highest state of charge.

12. The multi-bay power supply of claim 1, wherein the tolerance is a scalar value representative of an allowable difference between a voltage value of the energy storage device having the highest state of charge and a voltage value of any other of the energy storage devices in the plurality of energy storage devices.

13. A method of discharging a multi-bay power supply, the multi-bay power supply including a plurality of energy storage devices, a power output configured to provide power from the plurality of energy storage devices to a peripheral device, and a controller including an electronic processor, the method comprising:
determining, using the controller, which energy storage device in the plurality of energy storage devices has a highest state of charge;
activating, using the controller, the energy storage device having the highest state of charge to enable power flow from the energy storage device having the highest state of charge to the peripheral device;
discharging, using the controller, the energy storage device having the highest state of charge for a first configurable amount of time;
determining, using the controller, whether any energy storage devices in the plurality of energy storage devices have a state of charge that is within a tolerance of the highest state of charge;
activating, using the controller, any energy storage devices in the plurality of energy storage devices having a state of charge that is within the tolerance of the highest state of charge to enable power flow from the energy storage devices having states of charge within the tolerance to the peripheral device; and
discharging, using the controller, the energy storage device having the highest state of charge and the energy storage devices having states of charge within the tolerance for a second configurable amount of time.

14. The method of claim 13, wherein activating the energy storage device having the highest state of charge includes turning on a switch, by the controller, that is provided on a current path from the energy storage device having the highest state of charge to the peripheral device.

15. The method of claim 13, further comprising:
reading, by the controller, updated state of charge values of energy storage devices included in the plurality of energy storage devices after the second configurable amount of time has passed.

16. The method of claim 13, wherein the peripheral device is a heated article of clothing.

17. A method of charging a multi-bay battery system, the multi-bay battery system including a plurality of energy storage devices, a power input configured to provide power from an external power source to the plurality of energy storage devices, and a controller including an electronic processor, the method comprising:
determining, using the controller, which energy storage device in the plurality of energy storage devices has a lowest state of charge;
activating, using the controller, the energy storage device having the lowest state of charge to enable power flow from the external power source to the energy storage device having the lowest state of charge;
charging, using the controller, the energy storage device having the lowest state of charge for a first configurable amount of time;
determining, using the controller, whether any energy storage devices in the plurality of energy storage devices have a state of charge that is within a tolerance of the lowest state of charge;
activating, using the controller, any energy storage devices in the plurality of energy storage devices having a state of charge that is within the tolerance of the lowest state of charge to enable power flow from the external power source to the energy storage devices having states of charge within the acceptable tolerance; and
charging, using the controller, the energy storage devices having the lowest state of charge and the energy storage devices having states of charge within the acceptable tolerance for a second configurable amount of time.

18. The method of claim 17, wherein activating the energy storage device having the lowest state of charge comprises turning on a switch, by the controller, that is provided on a current path from the external power source to the energy storage device having the lowest state of charge.

19. The method of claim 17, further comprising:
reading, by the controller, updated state of charge values of energy storage devices included in the plurality of batteries after the second configurable amount of time has passed.

20. The method of claim 17, wherein the power input includes a USB-C port.
